(19) United States
(12) Patent Application Publication
(10) Pub. No.: US 2015/0134434 A1
(43) Pub. Date: May 14, 2015

(54) Method for determining a consumer's satisfaction for a product

(71) Applicants: LVMH RECHERCHE, Saint Jean de Braye (FR); INSTITUT DES SCIENCES ET INDUSTRIES DU VIVANT ET DE L'ENVIRONNEMENT, Paris (FR); INSTITUT NATIONAL DE RECHERCHE AGRONOMIQUE, Paris (FR)

(72) Inventors: Jean-Marc R. SIEFFERMANN, Levallois-Perret (FR); Nathalie WANTZ, Chatillon (FR); David BLUMENTHAL, Paris (FR); Eleonore LOESCHER, Paris (FR); Germaine GAZANO, Levallois-Perret (US)

(21) Appl. No.: 14/512,152

(22) Filed: Oct. 10, 2014

Related U.S. Application Data
(60) Provisional application No. 61/890,597, filed on Oct. 14, 2013.

(51) Int. Cl. G06Q 30/02

(52) U.S. Cl. CPC G06Q 30/0217; G06Q 30/0201; G06Q 30/0271
USPC 705/14.19

(57) ABSTRACT

The aim of the present invention is to improve the insight provided by conventional consumer studies. This question is particularly relevant in the case of selective products, where consumers rarely have the opportunity to fully compare and test a very wide assortment of products before eventually choosing one of them. The method of the invention provides an indication that a consumer is actually ready to purchase and use a particular product among numerous other products.

In the method of the invention, the consumer tests the products one after another in a random order. After having trialed a product, he must indicate whether he is sufficiently satisfied with it, and must make a choice: either the product is sufficiently satisfactory, and the test is over, with the consumer not trying any other products, or else the product is not satisfactory at all, and he goes on to the next product. The method of the invention is original in that the consumer can never go back, even if, eventually, he decides, after having trialed the next product, that he prefers the previous product.

The present invention provides a new consumer test and use thereof as a forecasting tool, as a marketing tool, or as a means of establishing loyalty.

When a consumer purchases or rents a product he has not had any direct use of, the choice is made arbitrarily. The reason is that, owing to limited time and to cost, it is not possible to purchase all of the products available, in order to allow the consumer to build his own experiment.

It is therefore common for a consumer to feel disappointment or dissatisfaction after the purchase and use of a new product. On a subsequent purchase, the consumer then chooses another product, hoping thereby to find a product that provides him with satisfaction.

There is therefore a sharp divide between the reality confronting a new user as he makes his purchase, and the conventional consumer tests as conducted, wherein a single consumer is presented successively or simultaneously with a set of products for him to compare.

The inventors have therefore designed a new method which attempts to get very close to the actual experience of a consumer. This new method evaluates the degree of sufficient satisfaction of the consumer with a product, which will allow him to choose the product, and the degree of dissatisfaction with a product, which will drive him to trial another product.

In the method of the invention, when the consumer stops at a product, he does so either because he has hit upon a favorite product, or on a product which is sufficiently satisfactory in relation to his own expectations.

The participant is unable to go back to a product which has been previously rejected, and is also unable to get to know the products before their individual presentation. The participant is preferably informed of the particulars of the method.

The method of the invention therefore allows more effective discrimination of the test products than in a conventional consumer test run on a sequential monadic basis.

The method of the invention has the advantage, moreover, of resembling the act of purchase: a consumer rarely is able to test all of the products on the market before choosing the most suitable.

In a conventional consumer test, a person is asked to trial a number of products one after another in a certain order, and to evaluate the product by giving each of the products a score (if the means of evaluation is a scoring scale comprising a minimum and a maximum) which conveys his level of appreciation for a particular criterion. This criterion is very often a constituent characteristic of the product (taste, texture, flavor or fragrances, appearance) or of its primary or secondary packaging. A conventional test is generally performed on a preselected panel in sequential monadic mode: each participant tests a first product, evaluates it using the evaluation grid he is provided, then tests a second product, but without a direct, conscious comparison with the products tested previously.

It is also possible to carry out studies aimed at driving the choice of the evaluator, by asking him to compare a panel of products in pairs, so as to give the choice a hierarchy, depending on the frequency of selection. This type of method has the drawback of taking up time, since, according to the method, all of the samples or all of the pairings of samples must be evaluated by the evaluator.

There may also be a limit in this case owing to the number of samples for study, if the evaluator is unable to carry through the test to the end without “sensory fatigue”, in the case, for example, where he is testing strongly odorous products, which saturate the odor receptors, or products with a very pronounced taste.

There are methods in the prior art that have attempted to overcome these drawbacks.

U.S. Pat. No. 6,623,040 describes a method that attempts to limit the number of tests, allowing information to be collected concerning the probability that a product will be chosen; however, this method requires testing of all of the samples of the panel, then processing of the information collected and application of statistical correlations whose model is complex.

In conventional hedonic studies, however, the level of the hedonic scores does not necessarily indicate that the consumer really wishes to choose and/or purchase and then use one specific product among many.

In conventional studies based on hedonic scores, a consumer is frequently asked to evaluate and score a large number of products in a limited time. For a consumer, however, it is not possible to purchase and test a large number of products in order to choose the product he will use every day. The level of the hedonic score does not necessarily indicate that the consumer really wishes to choose a specific product.

The aim of the present invention is to improve the data provided by these consumer studies. This question is particularly relevant in the case of selective products, where consumers rarely have the opportunity to fully compare and test a very large set of products before eventually choosing one. The method of the invention provides an indication that a consumer is actually ready to purchase and use a specific product among many others.

In the method of the invention, the consumer tests the products one after another, as in a prior-art test. However, after having trialed a product, he is required to indicate whether he is sufficiently satisfied with it, and to make a choice: either the product is sufficiently satisfactory, and the test is over, with the consumer not trying any other products, or else the product is not satisfactory at all, and he goes on to the next product. The method of the invention is original in that the consumer can never go back, even if, eventually, he decides, after having tried the next product, that he prefers the previous product; in that he does not necessarily test all of the products before making his choice and stopping the test; and also in that he is rewarded for his choice by a reward directly related to the product he has selected.

In the method of the invention, the consumer is required to weigh two risks: the risk of stopping too early and of failing to trial a product which might be better than the one with which he is satisfied, and the risk of continuing the test and of giving up the chance of receiving his preferred product as a present. The method of the invention is particularly informative in so far as the consumer, motivated by the prospect of a reward, is very involved in his choice. According to the method of the invention, the higher the frequency with which a product is chosen, the higher the probability that the product provokes a positive response in the consumer.

Another advantage of the method of the invention is that it does not require the evaluator to test all of the products before selecting a favorite, thereby allowing time to be saved and preventing the risk of “sensorial fatigue” in the evaluators, which may be detrimental to a possible positive response for a product under test, or may lead to premature ending of the test.

In the prior-art methods where the individual is forced to choose from a panel, the individual is required to trial the entirety of a set of products, before comparing them, so that the evaluation step is made at the end of the trials. In contrast, in the method of the invention, the choice and the evaluation are made during the test. This is made possible by increasing the trial individual's involvement, to whom a reward is given, and by causing him at each step to evaluate the risk of stopping the test.

The method of the invention permits better differentiation of products, even when the number of products being studied is higher.

This methodology also allows greater participant involvement; their choice is therefore more considered or more reliable.

This method, lastly, makes it possible to identify more certainly the product on which information or communication in the consumer direction should be focused.

Lastly, with the methodology of the invention, the choice is made immediately after evaluation of each product, by contrast with the two prior-art methods: the choice is therefore made on the evaluation which has just been carried out, and not retrospectively on the memory of the previous evaluations.

### SUMMARY OF THE INVENTION

The invention accordingly provides a method allowing an evaluation to be made of the interest a product may elicit in a consumer, said method proposing the testing of a number of products, subject to two conditions: an individual must make a choice about a product which satisfies him, without being able to go back on this choice and, once his choice is made, he receives a reward in direct relation to this product.

According to a variant of the method, the individual chooses, or the person conducting the method causes choice to be made of, the samples of the product according to a sequential monadic mode.

This method may be used to determine which among a number of versions of a product one is preparing to market might have the greatest success. It may also be used to establish the loyalty of a consumer who has tried a product that has already been marketed.

In addition, the invention provides a method for evaluating the degree of appreciation of a product by an individual, comprising the series of steps below:

a) selecting a set of at least two samples of products for testing;
b) selecting at least one individual;
c) providing the individual with or causing him to choose a first sample from the set of samples, and causing him to test the product of the first sample;
d) giving the individual the choice to test a second sample from the set of samples not yet tested, or to receive a reward directly relating to the sample of the product he has previously tested;
e) collecting where appropriate at least one datum relating to the degree of appreciation by the individual of the sample corresponding to the reward product;
f) repeating if necessary steps c) to e) until the individual has chosen to receive a reward, without giving him the possibility of going back on his choice, or until the individual has tested the last sample of the set;
g) giving the individual the reward;
h) processing the data collected concerning the degree of appreciation by the individual in relation to the sample chosen as reward, and optionally concerning the sample or samples which have not been chosen.

This method allows an evaluation to be made in particular of the degree of purchasing intention of a consumer for a product, or the positive response a product may provoke in a consumer, particularly when the product has not yet been marketed.

The method of the invention is able in particular to identify a product on which a communication or advertising effort is to be made.

The method of the invention has the advantage of isolating a favorite product within a set of several products, reliably, by selecting a team of test individuals that is much smaller than that required in the prior art in a conventional sequential monadic test. The trial duration according to the method of the invention is equal to or shorter than that of the conventional trial methods. The method of the invention provides an increase in the involvement of individuals, relative to the prior-art methods, by providing them in particular with a reward related to their favorite product.

The invention may be applied to a single trial individual or to a group of trial individuals.

### DESCRIPTION OF THE FIGURES

FIG. 1 shows the averages scores awarded by a panel, on a hedonic scale, to ten beauty creams, according to a prior-art method.

FIG. 2 represents, for each of the ten preceding beauty creams, the number of times it has been chosen, employing the method of the invention.

FIG. 3 represents, for each of the ten preceding beauty creams, the number of times it has been chosen relative to the number of times it has been trialed, employing the method of the invention.

FIG. 4 shows the averages scores awarded by a panel, on a hedonic scale, to eight deodorants, according to a prior-art method.

FIG. 5 represents, for each of the eight preceding deodorants, the number of times it has been chosen, employing the method of the invention.

FIG. 6 represents, for each of the eight preceding deodorants, the number of times it has been chosen relative to the number of times it has been trialed, employing the method of the invention.

FIG. 7 represents, for five nail varnishes existing on the market, the number of times it has been chosen, employing the method of the invention.

FIG. 8 represents, for each of the five preceding nail varnishes, the number of times it has been chosen relative to the number of times it has been trialed, employing the method of the invention.

### DETAILED DESCRIPTION OF THE INVENTION

The invention provides a method for evaluating the degree of appreciation of a product by an individual, comprising the series of steps below:

a) selecting a set of at least two samples of products for testing;
b) selecting at least one individual;
c) providing the individual with or causing him to choose a first sample from the set of samples, and causing him to test the product of the first sample;
d) giving the individual the choice to test a second sample from the set of samples not yet tested, or to receive a reward directly relating to the sample of the product he has previously tested, corresponding preferably to a product which is identical or very similar to said sample;
e) collecting where appropriate at least one datum relating to the degree of appreciation by the individual of the sample corresponding to the reward product;
f) repeating if necessary steps c) to e) until the individual has chosen to receive a reward, without giving him the possibility of going back on his choice;
g) giving the individual the reward;
h) processing the data collected concerning the degree of appreciation by the individual in relation to the sample chosen as reward, and optionally concerning the sample or samples which have not been chosen.

The method of the invention is original in that the consumer is unable to go back after having decided on his choice, and in that he receives a reward directly connected with the product he has chosen.

A “product” in the sense of the invention is any consumable product as such, or an audiovisual medium such as a soundtrack, an image or a video that represents such a product or one of its functionalities.

Within the set of samples put together for realizing the evaluation method of the invention, it is possible to choose to include both at least one new product and at least one existing product already on the market. Alternatively, it is possible to include therein only products which the individual will not have been able to have already purchased or used.

The method may be conducted on a single trial individual or on a number of trial individuals.

According to one variant of the method, at least two trial individuals are selected, forming a group of trial individuals, and steps c) to h) are repeated with each individual. This panel method allows, for example, the testing of a product which does not yet exist on the market, or the singling out, from among a number of equivalent products, of the one which may bring the greatest commercial success.

The individuals may be experts, persons selected at random in the street or in a shop, persons registered on a database, or persons who meet certain criteria after having responded to a questionnaire.

The sampling of the individuals may or may not be probabilistic (quotas, voluntary participation, age ranges). The individuals may be consumers of similar products, consumers of one of the products in the set of samples, or consumers of a product marketed by a competitor company.

The number of individuals in the trial group may be defined so as to establish a group which is representative of a wider population, in its average but also in its diversity.

In step b), it is possible advantageously to select individuals who have—before being selected—already used products equivalent to the products of the samples of the set selected in step a), in order to make the method more discriminating. All of the individuals in the group, for example, may have in common the fact of being regular users of a commercialized product.

The number of samples to be tested and the number of individuals in the trial group are generally adapted in line with one another.

The level of information provided to the consumer before and during the test can vary depending on the type of product to be tested or the number of products in the sample group (total number of products, information about the products, value of the reward).

Prior to step c), the individual may be told what will be the pattern of the method, and the number of samples he is able to test. It is possible not to tell the individual the number of samples making up the set of samples.

It is also possible to tell him only certain features of the test, especially the impossibility of going back on his final choice, or else the halting of the test once he has chosen to receive the reward. During step c), it is possible to tell and/or lay down to the individual a protocol of use for the sample he is testing—in particular, how and how frequently to use the sample of product.

According to one protocol imposed on the individual, he may trial the product a single time or a number of times a day, or even over at least two consecutive days. The frequency and the schedule of trialing will be defined depending on the category of product to be tested. For example, for a beauty cream, the sample of cream will preferably be applied once or twice a day for at least one to three weeks if the aim is to evaluate its effect on the skin.

The product to be tested is presented to the individual in the form most suitable to the test and/or to the data it is desired to collect.

The product may be made up of one or more product units given to the individual for the test. It may be presented in a single-unit container (e.g.: food product) or else in a multi-unit container (e.g.: beauty cream).

It is possible to ensure the random nature of the choice of the sample. In this case, all of the samples in the set may be presented at the same time to the individual in the same packaging, with said packaging providing no information about the price, the brand, and the usage of the sample of product, especially when the aim is to carry out evaluation of the container.

It is possible to select a set of at least two samples of cosmetic products to be tested which have different packaging and contain the same product. Conversely, it is possible to select a set of at least two samples of cosmetic products to be tested which have identical packaging and contain different products.

It is possible, on the other hand, to set a specific order in which the samples will be tested by the individual. This variant is of particular interest when the samples differ in an increasing degree of intensity (concentration of sugar or of sweetener, concentration of fragrance).

In the methods of the invention, the order in which the samples for trial are supplied to the individuals may be random, as for example by drawing of a sample from among all of the untested samples, or else it may be established prior to the start of the test, bearing in mind that, if it is established beforehand, it may not be identical for all of the individuals testing the products. In the context of the method, a balanced presentation plan may be established for the samples to be tested, that applies to all of the individuals in the trial group.

The individual may or may not be aware of the total number of samples he is able to test in the context of the method.

The individual may be told—before testing the first sample—the nature or the quantity of the reward he is able to receive, in order to bolster his involvement in the test.

However, the reward the individual receives is always related to the product he has tested.

In the case where he is testing cosmetic products, food products, or hygiene products, the individual may, for example, receive as a reward a given quantity of the product corresponding to the sample he has finally chosen.

The trial may be carried out in situ or at home.

The sample of product may be trialed by the individual in his home or in a location common to all the individuals in the group of trial individuals, according to a protocol which will have been explained to him beforehand. The sample of product may also be trialed by the individual at a point of sale or on a promotion stand.

The individual is able to trial the sample for a variable time, which he is given or which he chooses, and which may be between 10 minutes and one month.

If the individual has chosen to select a second sample to trial, the session to trial this second sample is preferably at least a day apart from the session to trial the first sample, in order to avoid any possible comparison of the two samples by the individual. If the trial is conducted at home, the individual will be asked to return the first sample in order to receive the second, unless he selects a reward in connection with the first.

In the method of the invention, the evaluation of the sample by the individual may involve a constituent characteristic of the product and/or a sensory analysis that is based on at least one sense selected from touch, smell, vision, hearing or taste, and/or an analysis of the primary and/or secondary packaging in which the product is contained.

The evaluation of the sample will preferably involve giving a positive or negative overall appreciation of the sample.

According to the method of the invention, the individual is allowed to choose to receive a reward in relation to the product corresponding to the sample, or to choose to trial another sample without the option of going back.

According to one embodiment of the invention, the individual is simply asked whether he does or does not like the product. This can be done by posing an overall question of estimation of preference.

In addition, the individual may be asked to give an appreciation score on a structured or unstructured scale. The scale may be numerical, semantic, or both numerical and semantic.

The individual may also be asked to fill in a questionnaire concerning the product corresponding to the sample he has trialed, or concerning the reasons for his choice.

In step e), the individual may be given a questionnaire about the reasons for his choice. The individual may be asked to explain the reasons for his choice, using closed or open questions, allowing the individual to express himself freely without being subject to a descriptive list, or without providing him with a list of preset questions, so as not to distort the hedonic response. This questionnaire, for example, will differentiate the data relating to an individual who has chosen a sample because he wished to stop the test, or because he failed to make a decision owing to a lack of perception of difference between the samples he had already trialed.

The individual is preferably required to return the first sample before possibly trialing a second, so that he is unable to compare directly a number of samples in the course of a single trial session.

When the individual has trialed all of the samples in the set, and if he has not been satisfied with the last sample, it is no longer possible for him to go on to the next one. In this case, a decision may be made to take no account of the data relating to this individual, or a proposal will be made to him to start the series of steps c) to e) again, until he chooses to receive a reward corresponding to a sample that satisfies him.

According to one particular embodiment, between steps b) and c) of the method of the invention, the individual may be supplied, before the start of the test, with a first, so-called “warm-up” sample, which does not form part of the samples of the test, in order to better appreciate the test conditions. In this case, he uses the “warm-up” sample according to the same protocol of use as that which he is given for the samples in the test. The individual is unable to claim a reward for the “warm-up” sample and is required necessarily to take up the method again at step c).

Where the method is applied to a group of trial individuals, it is possible to provide a step i), during which the data concerning the degree of satisfaction are processed.

For example, it is possible to calculate the ratio between: 1) the total number of times a sample of product has been chosen by all of the individuals in the group, and 2) the number of times the same sample of product has been tested by all of the individuals in the group.

It is also possible to count the total number of times a sample of product has been chosen or evaluated by all of the individuals in the trial group.

The reward given to the individual is directly related to the sample of product he has most recently tested. Said reward may be composed of all or part of the sampled product, or of a product similar to the chosen sample.

The reward given to the individual may therefore take a number of forms. It may, for example, consist of vouchers for the product chosen, or of at least one unit of the product chosen. In addition, the reward may preferably involve the individual being given on a free basis at least one product identical to the sample of product he has last tested. The individual may receive a quantity of product required for use over a month, for example.

The reward will depend on the constraints imposed on the individual when he is required to trial the samples. It will be sufficiently great for the individual to be involved in the test.

The methods of the invention can be applied to all current consumer goods, in particular to automobiles, to luxury leather goods, to clothes, to textiles, to food products, to body hygiene products, to cosmetic beauty and makeup products, to liqueurs and alcoholic drinks, and to perfumery products (scents and eaux de toilette).

The method of the invention is particularly suited to the evaluation of products with a relatively long time of use and for the evaluation of products of high cost, for which it is more difficult to change product in the event of dissatisfaction.

Among the hygiene products, mention may be made of shower gels, shampoos, and deodorants. Among the cosmetic products, mention may be made of lipsticks, face creams, and mascaras.

The methods of the invention may be applied to direct sensorial experimentation on the product. They may also be applied to audiovisual media presenting a product, such as a video which presents its technical characteristics, or an advertising film. The video may be viewed at home on the Internet.

The methods of the invention may be guided by a computer program in the form of an application or of software installed on a computer terminal such as a computer, a tablet, or a smartphone.

In one particular embodiment of the method, the individual views the sample of product on the screen of the computer terminal, more particularly a touchscreen.

As a nonlimiting example of implementation, the individual may be presented on a screen, advantageously a touchscreen, which carries a photo of the sample and/or a reference to identify it, and two buttons labeled in one case “next sample” and in the other case “reward”, with the individual choosing to click/touch one of these two buttons in order to validate his choice.

The method of the invention makes it possible to identify one or more products capable of generating a level of satisfaction or contentment that is sufficiently high that a consumer will not test other products, and to which therefore he will probably be more loyal if they are commercialized. This method therefore makes it possible to select the “favorite” product for development with a view to commercialization.

The method of the invention also allows identification of the product on which to focus communication, or the demonstration product to be given out at a point of sale.

The method of the invention may serve to evaluate the degree of the consumer's intention to purchase a product, or to evaluate the positive response a product may provoke in the consumer.

This method, when it is employed at a sales location, allows the loyalty of the consumer to be established for a product. It also allows the sales offer to be personalized for a consumer, after an evaluation has been made of his needs, in order to provide him with a set of samples for testing that is related to the prior evaluation of his needs.

The invention is illustrated by the examples which follow.

### Example 1

### Comparison of Hedonic Scores with the Method of the Invention on Selective Skin Care Products

The object of this study was to investigate and compare the method of the invention with hedonic scores, within an in-use study.

The study was done on a full set of 10 new selective skin care products, chosen in order to cover a wide range of texture sensations. The same product set was independently studied for the two methodologies.

Methodology of the Prior Art

250 consumers (French women aged 20 to 60, all heavy users of selective skin care products) took part in a conventional consumer study. Products were given in 2 goes (the first 5 products, then the last 5 products) and were evaluated at home (3 days per product) in a monadic sequential way (products tested one after another, without direct comparison). The questionnaire included questions about the global hedonic score (on a 0 to 10 hedonic scale), purchase intent, satisfaction, as well as sensory properties and moisturizing perception.

Method of the Invention

60 other French women (same age range and also heavy users of selective skin care products) took part in the study.

Products were tested at home (3 days in-use conditions). Products were presented to them in a monadic sequential way. These women always had only one product at a time and never had the opportunity to directly compare the products.

These women were asked after the 3 day test if they were satisfied enough with the current tested product. If so, the test was over and they were rewarded by receiving as a substantial gift the equivalent of one month's use of that specific product. If not, they were given the next product to test while the previous product was taken back. The procedure continued until a product was finally chosen by the consumer. In any case, the chosen product had to be the last one tested, and could never be a previously rejected one.

In both studies, the same Latin square design was used to establish the sequence of the products' evaluation.

Results

Results—Methodology of the Prior Art

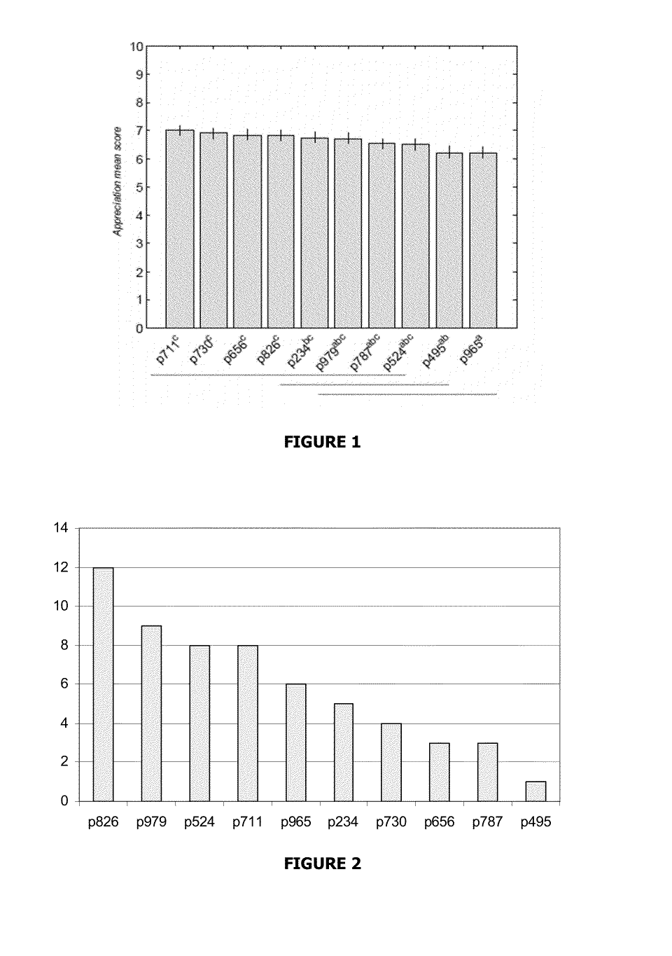

Before any segmentation of the whole 250-consumer panel, the study was unable to reveal a “most interesting product” among products with very similar hedonic scores. Mean product scores ranged between 6 and 7 on a 0 to 10 hedonic scale (FIG. 1). Anova showed a significant product effect (1%) while at the same time the 8 preferred products were not significantly different (Bonferroni 5%).

Results—Method of the Invention

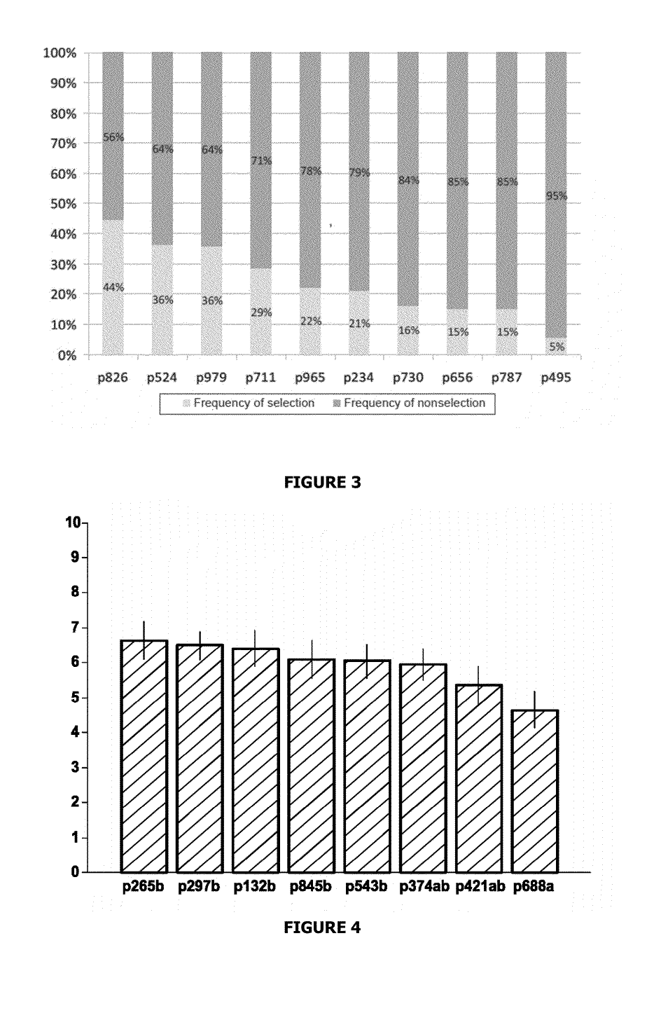

The main result of the method of the invention looks at the number of consumers who stop and decide to keep a specific product (FIG. 2). By doing this, these women show that this specific product is interesting enough for them. As all the products are not seen and evaluated by the same number of consumers, one can also look at the frequency rate of choice of a specific product compared to the number of times this product has been tested (FIG. 3).

Both figures show much more contrasting results than for the main methodology. There are 3 products (products 826, 524, 979) which are chosen more often than others, one (product 826) being significantly (Fischer 5%) a clear leader.

Results—Comparison of Both Methodologies

Considering the results on the whole panel of 250 consumers and before any segmentation, it was difficult to choose the “most interesting product” between products with quite similar high scores. On the contrary, the method of the invention provided a much clearer result by highlighting the 3 products on which a majority of consumers chose to stop the test and said they were satisfied with them.

These 3 products were actually among the 8 preferred products of the main methodology but nothing distinguished them from the 5 others. The method of the invention allowed highlighting of the fact that those 3 products gathered half of the consumers' choices. Moreover one product (product 826) was chosen by 20% of the consumers (twice the frequency of a random consumer choice).

In addition, it was not possible to cluster the 250 consumers of the main methodology into 4 consumer groups. It showed that the 3 products emerging from the method of the invention appear indeed among the preferred products of one or the other of the consumer groups of the segmentation.

### CONCLUSION

The method of the invention provided clearer and more decisive information on the potentially most interesting products. Besides, the result was obtained with four times less consumers than the reference test methodology.

The trial duration according to the method of the invention is equal to or shorter than that of the conventional trial methods, but the reward has to be of a high significant value to motivate the consumers' decision. Given the in-use test methodology, it required a strict logistic procedure to provide the consumers with the products one by one while at the same time getting the used products back. As such, it is more time consuming for both the fieldwork manager and the consumers, but again, the reward value compensates for the higher appointment constraints.

In conclusion, with the prior-art method, a group of eight more highly estimated products is identified, whereas the method of the invention allows the identification of a single product which is chosen more often than the others.

### Example 2

### Comparison of Hedonic Scores with the Method of the Invention on Deodorant Products

The object of this study was to investigate and compare the results the method of the invention with habitual hedonic scores within an in-use study. The study was done on a set of 8 spray-on deodorants, chosen in order to cover a wide range of the actual female deodorant market. The same product set was independently studied using the two methodologies.

Materials and Methods

A set of 8 spray-on deodorants was selected for this study. Products were mass market products chosen to cover the diversity of the French female market. Samples were presented in a non-anonymous way and were different in terms of perfumes, colors, shapes and claims. They were tested as they were available on the market.

The same product set was independently studied using the two methodologies.

Methodology of the Prior Art

60 consumers (French women aged 18 to 60) took part in a conventional consumer study. Products were given one by one in a monadic sequential way and were evaluated at home (one day per product). The questionnaire included questions about the global hedonic score (on a 0 to 10 hedonic scale), demographics and consumer habits.

Method of the Invention

60 other French women (same age range from 18 to 60) took part in the prospective methodology.

The main idea of the method of the invention is to force a consumer to make up his mind about one product and take a decision. The products are presented in a sequential way. For the current deodorant study, products were evaluated at home (one day per product). At each product, the consumer has to decide whether he is satisfied with the product and keeps it, or wants to test a new one. Once the keeping choice is made, he is effectively rewarded with a substantial amount of the chosen product. This reward is a huge asset for the commitment of the consumer during the test. Conversely, once he has rejected a product, his decision is final and that product cannot be his final choice. That implies that the consumer has to make his decision based on the fact that the product he is currently evaluating is satisfying enough. He does not want to try another one, even by taking the risk to miss a better product.

In both studies, a Latin square design was used to establish the sequence of the products' evaluation.

Results

Results—Methodology of the Prior Art

Mean product scores ranged between 4, 5 and 7 on a 0 to 10 hedonic scale (FIG. 4). Anova showed a significant product effect (1%) while at the same time the 6 preferred products were not significantly different (Bonferroni 5%). The study was unable to reveal a “most interesting product” among products with the higher and very similar hedonic scores.

Results—Method of the Invention

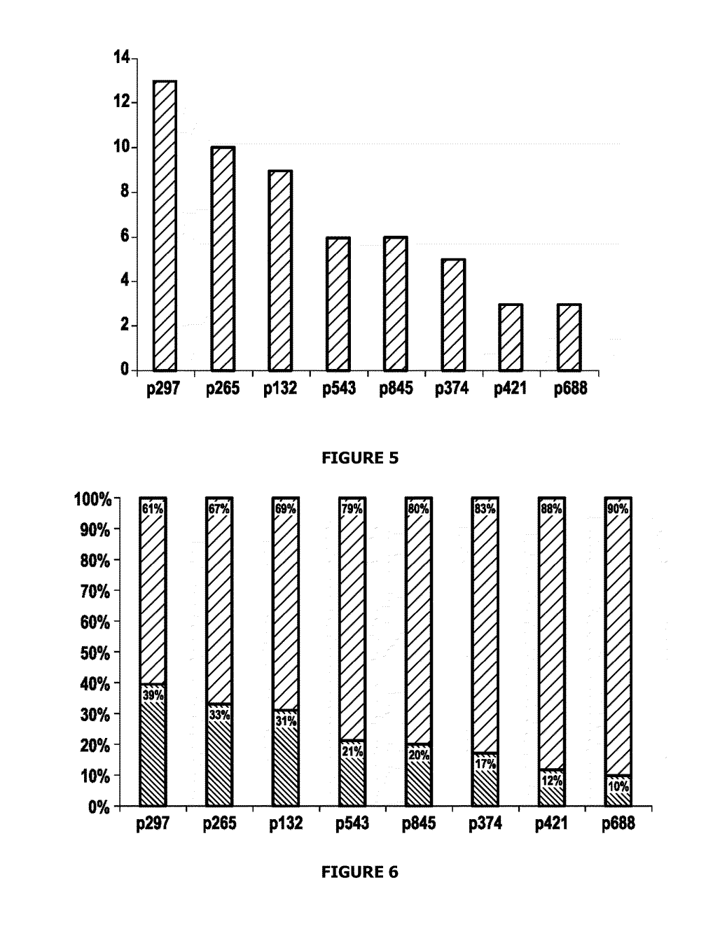

The main result of the method of the invention looks at the number of consumers who stop and decide to keep a specific product (FIG. 5). By doing this, these women show that this specific product is interesting enough for them. As all the products are not seen and evaluated by the same number of consumers, one can also look at the frequency rate of choice of a specific product compared to the number of times this product has been tested (FIG. 6).

Both figures show much more contrasting results than for the main methodology. There are 3 products (products 297, 265, 132) which are chosen more often than others, one (product 297) being significantly (Fischer 5%) a clear leader.

Results—Comparison of Both Methodologies

The method of the invention provided, with the same number of consumers, and within the same period of time, a much clearer result by highlighting one product and two additional ones among the preferred ones. These 3 products were among the 6 preferred products of the conventional methodology. The method of the invention allowed highlighting of the fact that those 3 products gathered more than half of the consumers' choices. Moreover one product (product 297) was chosen by 20% of the consumers in the method of the invention (twice the frequency of a random consumer choice).

### Example 3

### Consumer Study on Virtual Products

82 women, aged from 20 to 62, evaluated five mascaras which were presented virtually (video of the mascara brush revolving, benefits of the mascara, and price) according to the method of the invention.

The method identified two sufficiently satisfactory mascaras.

### Example 4

### Consumer Study on Nail Varnishes

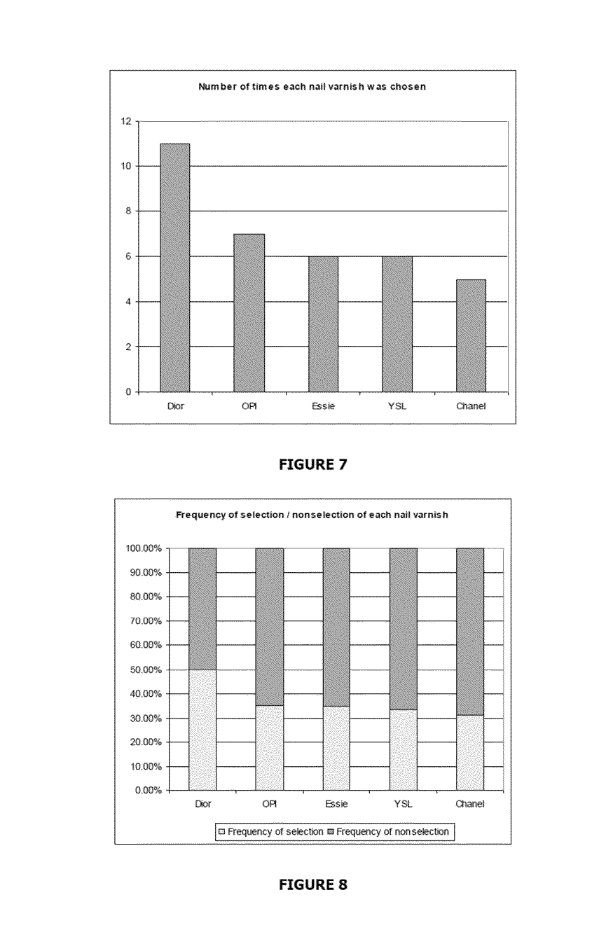

35 women, aged from 26 to 63, who were regular users of nail varnishes in the selective market, tested five nail varnishes of the brands Dior, OPI, Essie, YSL, and Chanel, over four days each, according to the method of the invention. The results are presented in FIGS. 7 and 8.

The method of the invention identified a product chosen by a large majority.

1. A method for evaluating the degree of appreciation of a product by an individual, comprising the series of steps below:
a) selecting a set of at least two samples of products for testing;
b) selecting at least one individual;
c) providing the individual with or causing him to choose a first sample from the set of samples, and causing him to test the product of the first sample;
d) giving the individual the choice to test a second sample from the set of samples not yet tested, or to receive a reward directly relating to the sample of the product he has previously tested, corresponding preferably to a product which is identical or very similar to said sample;
e) collecting where appropriate at least one datum relating to the degree of appreciation by the individual of the sample corresponding to the reward product;
f) repeating if necessary steps c) to e) until the individual has chosen to receive a reward, without giving him the possibility of going back on his choice, or until the individual has tested the last sample of the set;
g) giving the individual the reward;
h) processing the data collected concerning the degree of appreciation by the individual in relation to the sample chosen as reward, and optionally concerning the sample or samples which have not been chosen.

2. The method as claimed in claim 1, wherein at least two trial individuals are selected that constitute a group of trial individuals, and wherein steps c) to h) are repeated with the other individuals.

3. The method as claimed in claim 2, wherein during a step i) a calculation is made of the ratio between: 1) the total number of times a sample of product has been chosen by all of the individuals in the group, and 2) the number of times the same sample of product has been tested by all of the individuals in the group.

4. The method as claimed in claim 2, wherein during a step i) a calculation is made of the total number of times a sample of product has been chosen by all of the individuals in the group.

5. The method as claimed in claim 1, wherein before step c) the individual is told the principle and/or steps of the method.

6. The method as claimed in claim 1, wherein all of the samples in the set are presented to the individual in the same packaging, said packaging providing no information concerning price, brand, and usage of the sample of product.

7. The method as claimed in claim 1, wherein the individual trials the sample of product in his home or at a point of sale.

8. The method as claimed in claim 1, wherein the method is guided by a computer program in the form of an application or software installed on a computer terminal such as a computer, a tablet or a smartphone.

9. The method as claimed in claim 8, in which the individual views the sample on the screen of the computer terminal.

10. The method as claimed in claim 1, wherein the individual is unaware of the number of samples making up the set of samples he is able to test.

11. The method of claim 1, wherein the individual—before testing the first sample—is told the nature of the reward he is likely to receive, in order to bolster his involvement.

12. The method as claimed in claim 1, wherein—in step b)—an individual is selected who has already—before being selected—used at least one product equivalent to the products of the samples of the set selected in step a).

13. The method as claimed in claim 1, wherein the reward comprises giving the individual on a free basis at least one product identical to the sample of product he has trialed and chosen.

14. The method as claimed in claim 2, wherein the number of individuals in the group is from five to ten times the number of samples of product.

15. The method as claimed in claim 1, wherein—in step e)—the individual is given a questionnaire concerning the reasons for his choice and/or concerning at least one constituent characteristic of the product or of its primary or secondary packaging.

16. The method as claimed in claim 1, wherein the product is a product presentation video, a cosmetic beauty product, a cosmetic makeup product, a hygiene product, or a scent.

17. The method as claimed in claim 1, wherein the product is an automobile or a food product.

18. A method for evaluating the degree of intention by the consumer to purchase a product, employing a method as claimed in claim 1.

19. A method for evaluating the positive response a product may provoke in the consumer, employing a method as claimed in claim 1.

20. A method for establishing the loyalty of a consumer for a product, employing a method as claimed in claim 1.

21. A method for personalizing the sales offer to a consumer, which comprises the following steps:
i) evaluating the needs of the consumer, and
ii) implementing a method as claimed claim 1, by selecting a set of samples for testing that is related to the prior evaluation of his needs.
